(19) United States
(12) Patent Application Publication
(10) Pub. No.: US 2005/0263407 A1
(43) Pub. Date: Dec. 1, 2005

(54) Electrochemical-mechanical polishing composition and method for using the same

(75) Inventors: Vlasta Brusic, Geneva, IL (US); Michael F. Richardson, Sugar Grove, IL (US); David J. Schroeder, Aurora, IL (US); Jian Zhang, Aurora, IL (US)

Correspondence Address: STEVEN WESEMAN;ASSOCIATE GENERAL COUNSEL, I.P., CABOT MICROELECTRONICS COPORATION, 870 NORTH COMMONS DRIVE, AURORA, IL, 60504, US

(73) Assignee: Cabot Microelectronics Corporation, Aurora, IL (US)

(21) Appl. No.: 10/857,432

(22) Filed: May 28, 2004

(51) Int. Cl. B23H 3/08

(52) U.S. Cl. 205/684

(57) ABSTRACT

The invention provides an electrochemical-mechanical polishing composition comprising: (a) a chemically inert, water-soluble salt, (b) a corrosion inhibitor, (c) a polyelectrolyte, (d) a complexing agent, (e) an alcohol, and (f) water. The invention also provides a method of polishing a substrate comprising one or more conductive metal layers, the method comprising the steps of: (a) providing a substrate comprising one or more conductive metal layers, (b) immersing a portion of the substrate in an electrochemical-mechanical polishing composition, the polishing composition comprising: (i) a chemically inert, water-soluble salt, (ii) a corrosion inhibitor, (iii) a polyelectrolyte, (iv) a complexing agent, (v) an alcohol, and (vi) water, (c) applying an anodic potential to the substrate, the anodic potential being applied to at least the portion of the substrate immersed in the polishing composition, and (d) abrading at least a portion of the immersed portion of the substrate to polish the substrate.

### FIELD OF THE INVENTION

This invention pertains to an electrochemical-mechanical polishing composition and a method for using the same in the electrochemical-mechanical polishing of a substrate comprising one or more conductive metal layers.

### BACKGROUND OF THE INVENTION

In the fabrication of integrated circuits and other electronic devices, multiple layers of conducting, semiconducting, and dielectric materials are deposited onto or removed from a substrate surface. Thin layers of conducting, semiconducting, and dielectric materials may be deposited onto the substrate surface by a number of deposition techniques. Deposition techniques common in modern microelectronics processing include physical vapor deposition (PVD), also known as sputtering, chemical vapor deposition (CVD), plasma-enhanced chemical vapor deposition (PECVD), and electrochemical plating (ECP).

As layers of materials are sequentially deposited onto and removed from the substrate, the uppermost surface of the substrate may become non-planar and require planarization. Planarizing a surface, or “polishing” a surface, is a process where material is removed from the surface of the substrate to form a generally even, planar surface. Planarization is useful in removing undesired surface topography and surface defects, such as rough surfaces, agglomerated materials, crystal lattice damage, scratches, and contaminated layers or materials. Planarization is also useful in forming features on a substrate by removing excess deposited material used to fill the features and to provide an even surface for subsequent levels of metallization and processing.

Chemical-mechanical planarization, or chemical-mechanical polishing (CMP), is a common technique used to planarize substrates. CMP utilizes a chemical composition, typically a slurry or other fluid medium, for selective removal of material from the substrate. In conventional CMP techniques, a substrate carrier or polishing head is mounted on a carrier assembly and positioned in contact with a polishing pad in a CMP apparatus. The carrier assembly provides a controllable pressure to the substrate, urging the substrate against the polishing pad. The pad is moved relative to the substrate by an external driving force. The relative movement of the pad and substrate serves to abrade the surface of the substrate to remove a portion of the material from the substrate surface, thereby polishing the substrate. The polishing of the substrate by the relative movement of the pad and the substrate typically is further aided by the chemical activity of the polishing composition and/or the mechanical activity of an abrasive suspended in the polishing composition.

Due to its desirable electrical properties, copper is being increasingly utilized in integrated circuit fabrication. However, the use of copper presents its own special fabrication problems. For example, the controlled dry etching of copper for ultra large-scale integration (ULSI) applications is very costly and technically challenging, and new processes and techniques, such as damascene or dual damascene processes, are being used to form copper substrate features. In damascene processes, a feature is defined in a dielectric material and subsequently filled with the conductive material (e.g., copper).

In order to ensure that the different features of relatively small integrated circuits (e.g., less than 0.25 micron or less than 0.1 micron) are sufficiently insulated or isolated from one another (e.g., to eliminate coupling or “crosstalk” between features), dielectric materials with low dielectric constants (e.g., less than about 3) are being used in the manufacture of damascene structures. However, low k dielectric materials, such as carbon doped silicon oxides, may deform or fracture under conventional polishing pressures (e.g., about 40 kPa), called “downforce,” which deformation or fracturing can detrimentally affect the substrate polish quality and device formation and/or function. For example, relative rotational movement between the substrate and a polishing pad under a typical CMP downforce can induce a shear force along the substrate surface and deform the low k material to form topographical defects, which can detrimentally affect subsequent polishing.

One solution for polishing conductive materials (e.g., copper) in low dielectric materials with reduced or minimal defects formed thereon is to polish the conductive material using electrochemical-mechanical polishing (ECMP) techniques. ECMP techniques remove conductive material from a substrate surface by electrochemical dissolution while concurrently polishing the substrate with reduced mechanical abrasion compared to conventional CMP processes. The electrochemical dissolution is performed by applying an electric potential or bias between a cathode and substrate surface to remove conductive materials from a substrate surface into a surrounding electrolyte or electrochemical-mechanical polishing composition.

While several suggested formulations for electrolytes or electrochemical-mechanical polishing compositions can be found within the art, few, if any, of these electrolytes or electrochemical-mechanical polishing compositions exhibit desirable polishing characteristics. For example, the suggested electrolytes or electrochemical-mechanical polishing compositions may exhibit polishing rates comparable with conventional CMP processes without the need for the application of an excessive downforce, but the electrolytes or electrochemical-mechanical polishing compositions can cause excessive dishing of the conductive material which can lead to erosion of the dielectric material. The topographical defects resulting from such dishing and erosion can further lead to non-uniform removal of additional materials from the substrate surface, such as barrier layer materials disposed beneath the conductive material and/or dielectric material, and produce a substrate surface having a less than desirable quality which can negatively impact the performance of the integrated circuit.

A need therefore exists for an electrochemical-mechanical polishing composition and method for using the same that exhibit relatively high removal rates of substrate material at low downforce while minimizing dishing and erosion of the substrate. The invention provides such an electrochemical-mechanical polishing composition and method for using the same. These and other advantages of the invention, as well as additional inventive features, will be apparent from the description of the invention provided herein.

### BRIEF SUMMARY OF THE INVENTION

The invention provides an electrochemical-mechanical polishing composition comprising: (a) a chemically inert, water-soluble salt, (b) a corrosion inhibitor, (c) a polyelectrolyte, (d) a complexing agent, (e) an alcohol, and (f) water.

The invention also provides a method of polishing a substrate comprising one or more conductive metal layers, the method comprising the steps of: (a) providing a substrate comprising one or more conductive metal layers, (b) immersing a portion of the substrate in an electrochemical-mechanical polishing composition, the polishing composition comprising: (i) a chemically inert, water-soluble salt, (ii) a corrosion inhibitor, (iii) a polyelectrolyte, (iv) a complexing agent, (v) an alcohol, and (vi) water, (c) applying an anodic potential to the substrate, the anodic potential being applied to at least the portion of the substrate immersed in the polishing composition, and (d) abrading at least a portion of the immersed portion of the substrate to polish the substrate.

### DETAILED DESCRIPTION OF THE INVENTION

The invention provides an electrochemical-mechanical polishing composition comprising: (a) a chemically inert, water-soluble salt, (b) a corrosion inhibitor, (c) a polyelectrolyte, (d) a complexing agent, (e) an alcohol, and (f) water.

The electrochemical-mechanical polishing composition of the invention can comprise any suitable chemically inert, water-soluble salt. As utilized herein, the term “chemically inert” refers to a salt that does not chemically react to an appreciable extent with the other components present in the electrochemical-mechanical polishing composition. Preferably, the chemically inert, water-soluble salt does not undergo any chemical reaction with the other components present in the electrochemical-mechanical polishing composition. As utilized herein, the term “water-soluble” refers to a salt having a solubility in water at typical electrochemical-mechanical polishing temperatures (e.g., about 25° C.) that is sufficient to reduce the electrical resistance of the electrochemical-mechanical polishing composition to a level suitable for electrochemical-mechanical polishing (e.g., about 100 Ohms or less, about 50 Ohms or less, about 20 Ohms or less, or about 1 Ohm or less). The chemically inert, water-soluble salt can be any suitable salt having the properties set forth above. Preferably, the chemically inert, water-soluble salt is selected from the group consisting of chlorides, phosphates, sulfates, and mixtures thereof. More preferably, the chemically inert, water-soluble salt is potassium sulfate.

The chemically inert, water-soluble salt can be present in the electrochemical-mechanical polishing composition in any suitable amount. Generally, the chemically inert, water-soluble salt is present in the electrochemical-mechanical polishing composition in an amount sufficient to reduce the electrical resistance of the electrochemical-mechanical polishing composition to a level suitable for electrochemical-mechanical polishing (e.g., about 100 Ohms or less, about 50 Ohms or less, about 20 Ohms or less, or about 1 Ohm or less). Preferably, the chemically inert, water-soluble salt is present in the electrochemical-mechanical polishing composition in an amount of about 0.1 wt. % or more, more preferably about 0.5 wt. % or more, based on the total weight of the polishing composition. Preferably, the chemically inert, water-soluble salt is present in the electrochemical-mechanical polishing composition in an amount of about 20 wt. % or less, more preferably about 15 wt. % or less, still more preferably about 10 wt. % or less, and most preferably about 4 wt. % or less, based on the total weight of the polishing composition.

The electrochemical-mechanical polishing composition of the invention can comprise any suitable corrosion inhibitor. Typically, the corrosion inhibitor is an organic compound containing a heteroatom-containing functional group. For example, the film-forming agent is a heterocyclic organic compound with at least one 5- or 6-member heterocyclic ring as the active functional group, wherein the heterocyclic ring contains at least one nitrogen atom, for example, an azole compound. Preferably, the corrosion inhibitor is selected from the group consisting of 1,2,3-triazole, 1,2,4-triazole, benzotriazole, benzimidazole, benzothiazole, and mixtures thereof. Most preferably, the corrosion inhibitor is benzotriazole. The electrochemical-mechanical polishing composition of the invention can comprise any suitable amount of the corrosion inhibitor. Typically, the corrosion inhibitor is present in the electrochemical-mechanical polishing composition in an amount of about 0.0001 wt. % to about 3 wt. %, preferably about 0.001 wt. % to about 2 wt. %, based on the total weight of the polishing composition.

The electrochemical-mechanical polishing composition of the invention can comprise any suitable polyelectrolyte. Preferably, the electrochemical-mechanical polishing composition comprises a polyelectrolyte selected from the group consisting of arabic gum, guar gum, hydroxypropyl cellulose, poly(acrylic acid), poly(acrylic acid-co-acrylamide), poly(acrylic acid-co-2,5-furandione), poly(acrylic acid-co-acrylamidomethylpropylsulfonic acid), poly(acrylic acid-co-methyl methacrylate-co-4-[(2-methyl-2-propenyl)oxy]-benzenesulfonic acid-co-2-methyl-2-propene-1-sulfonic acid), poly(acrylamide), poly(N-sulfopropyl acrylamide), poly (2-acrylamido-2-methylpropane sulfonic acid), poly(diallyl dimethyl ammonium chloride), poly(ethylene glycol), poly(ethylene imine) (e.g., a linear poly(ethylene imine)), poly(methacrylic acid), poly(ethyl methacrylate), poly(sodium methacrylate), poly(sulfopropyl methacrylate), poly(maleic acid), poly(maleic-co-olefin), poly(vinyl alcohol), poly(anilinesulfonic acid), poly(ethenesulfonic acid), poly(styrenesulfonate), poly(styrene-co-maleic acid), poly(sodium 4-styrenesulfonate), poly(vinylsulfonate), poly(vinyl pyridine), poly(sodium vinyl sulfate), poly(ethenesulfonic acid), succinylated poly-L-lysine, poly[aniline-co-N-(3-sulfopropyl) aniline], sodium alginate, xanthan gum, and mixtures thereof. More preferably, the polyelectrolyte is poly(acrylic acid). The polyelectrolyte can be present in the electrochemical-mechanical polishing composition in any suitable amount. Typically, the polyelectrolyte is present in the electrochemical-mechanical polishing composition in an amount of about 0.01 wt. % or more, preferably about 0.05 wt. % or more, more preferably about 0.1 wt. % or more, and most preferably about 0.5 wt. % or more, based on the total weight of the polishing composition. Typically, the polyelectrolyte is present in the electrochemical-mechanical polishing composition in an amount of about 20 wt. % or less, preferably about 15 wt. % or less, more preferably about 10 wt. % or less, and most preferably about 5 wt. % or less, based on the total weight of the polishing composition.

During conventional chemical-mechanical polishing processes, a complexing agent typically is used to enhance the removal rate of the substrate layer being removed. While the electrochemical bias applied to the substrate and polishing composition in an electrochemical-mechanical polishing process can provide a removal rate comparable to or greater than that attained using a complexing agent in a conventional chemical-mechanical polishing process, the ability to effectively control the removal of the substrate layer (e.g., the removal rate and the uniformity of removal) possible in an electrochemical-mechanical polishing process becomes a priority. In these situations (i.e., in electrochemical-mechanical polishing processes), it has been found that a complexing agent can be used to improve the ability to control the removal rate attributable to the electrochemical bias applied to the substrate and polishing composition while also improving the uniformity of such removal. Accordingly, the electrochemical-mechanical polishing composition of the invention can comprise any suitable complexing agent. The complexing agent is any suitable chemical additive that binds with a metal (e.g., copper) in solution and can enhance the removal rate of the substrate layer being removed.

Suitable chelating or complexing agents include monofunctional organic acids, difunctional organic acids, trifunctional organic acids, multifunctional organic acids (e.g., citric acid), inorganic acids (e.g., phosphoric acid, pyrophosphoric acid, nitric acid), aromatic organic acids, polar organic acids (e.g., lactic acid, methyl lactic acid, tartaric acid, malic acid), unsaturated organic acids, amino acids, aromatic amino acids (e.g., anthranilic acid, picolinic acid, hydroxypicolinic acid), morpholino compounds, and zwitterions (e.g., betaine). More specifically, suitable chelating or complexing agents can include, for example, carbonyl compounds (e.g., acetylacetonates, and the like), simple carboxylates (e.g., acetates, aryl carboxylates, and the like), carboxylates containing one or more hydroxyl groups (e.g., glycolates, lactates, gluconates, gallic acid and salts thereof, and the like), di-, tri-, and poly-carboxylates (e.g., oxalates, phthalates, citrates, succinates, tartrates, malates, edetates (e.g., dipotassium EDTA), mixtures thereof, and the like), carboxylates containing one or more sulfonic and/or phosphonic groups, and the like. Suitable chelating or complexing agents also can include, for example, di-, tri-, or polyalcohols (e.g., ethylene glycol, pyrocatechol, pyrogallol, tannic acid, and the like) and amine-containing compounds (e.g., ammonia, amino acids, amino alcohols, di-, tri-, and polyamines, and the like). The choice of suitable chelating or complexing agents will depend on the type of substrate layer (e.g., the type of metal) being polished. Preferably, the complexing agent is selected from the group consisting of carboxylic acids, di-carboxylic acids, tri-carboxylic acids, polycarboxylic acids, and mixtures thereof. More preferably, the complexing agent is selected from the group consisting of lactic acid, tartaric acid, citric acid, malonic acid, phthalic acid, succinic acid, glycolic acid, propionic acid, acetic acid, salicylic acid, picolinic acid, 2-hydroxybutyric acid, 3-hydroxybutyric acid, 2-methyl lactic acid, salts thereof, and mixtures thereof, and most preferably the complexing agent is lactic acid. It will be appreciated that many of the aforementioned compounds can exist in the form of a salt (e.g., a metal salt, an ammonium salt, or the like), an acid, or as a partial salt. For example, citrates include citric acid, as well as mono-, di-, and tri-salts thereof.

The complexing agent can be present in the electrochemical-mechanical polishing composition in any suitable amount. Typically, the complexing agent is present in the electrochemical-mechanical polishing composition in an amount of about 0.01 wt. % or more, preferably about 0.05 wt. % or more, more preferably about 0.1 wt. % or more, and most preferably about 0.5 wt. % or more, based on the total weight of the polishing composition. The complexing agent typically is present in the electrochemical-mechanical polishing composition in an amount of about 10 wt. % or less, preferably about 5 wt. % or less, based on the total weight of the polishing composition.

As noted above, the electrochemical-mechanical polishing composition of the invention comprises an alcohol. The electrochemical-mechanical polishing composition can comprise any suitable alcohol. Preferably, the alcohol is selected from the group consisting of methanol, ethanol, propanol (e.g., 1-propanol, or 2-propanol), butanol (e.g., 1-butanol, 2-butanol, or tert-butanol (i.e., 2-methylpropan-2-ol)), and mixtures thereof. More preferably, the alcohol comprises propanol (e.g., 2-propanol or isopropyl alcohol). Alternatively, the alcohol can be a branched or linear alcohol having a molecular weight greater than butanol.

The alcohol can be present in the electrochemical-mechanical polishing composition in any suitable amount, but typically is present in the electrochemical-mechanical polishing composition in an amount of about 5 wt. % or more based on the total weight of the polishing composition. Preferably, the alcohol is present in the electrochemical-mechanical polishing composition in an amount of about 10 wt. % or more, more preferably about 15 wt. % or more, based on the total weight of the polishing composition. Typically, the alcohol is present in the electrochemical-mechanical polishing composition in an amount of about 40 wt. % or less, preferably about 35 wt. % or less, more preferably about 30 wt. % or less, still more preferably about 25 wt. % or less, and most preferably about 20 wt. % or less, based on the total weight of the polishing composition.

In the electrochemical-mechanical polishing composition of the invention, a liquid carrier is used to dissolve the chemically inert, water-soluble salt and facilitate the application of the corrosion inhibitor, polyelectrolyte, complexing agent, alcohol, and any other additives to the surface of a suitable substrate to be polished or planarized. As noted above, the liquid carrier preferably is water (e.g., deionized water). The liquid carrier can further comprise a suitable water-miscible solvent. However, in certain preferred embodiments the liquid carrier consists essentially of, or consists, of water, more preferably deionized water.

The electrochemical-mechanical polishing composition can have any suitable pH. Typically, the electrochemical-mechanical polishing composition has a pH of about 13 or less. Preferably, the electrochemical-mechanical polishing composition has a pH of about 7 or less (e.g., about 6 or less, about 5 or less, or about 4 or less). Typically, the electrochemical-mechanical polishing composition has a pH of about 1 or more (e.g., about 2 or more).

The pH of the electrochemical-mechanical polishing composition can be achieved and/or maintained by any suitable means. More specifically, the polishing composition can further comprise a pH adjustor, a pH buffering agent, or a combination thereof. The pH adjustor can be any suitable pH-adjusting compound. For example, the pH adjustor can be potassium hydroxide, sodium hydroxide, ammonium hydroxide, or a combination thereof. The pH buffering agent can be any suitable buffering agent, for example, phosphates, acetates, borates, ammonium salts, and the like. The electrochemical-mechanical polishing composition can comprise any suitable amount of a pH adjustor and/or a pH buffering agent, provided such amount is sufficient to achieve and/or maintain the pH of the polishing composition within the ranges set forth herein.

The electrochemical-mechanical polishing composition optionally further comprises a surfactant. Suitable surfactants can include, for example, cationic surfactants, anionic surfactants, nonionic surfactants, amphoteric surfactants, mixtures thereof, and the like. Preferably, the polishing composition comprises a nonionic surfactant. One example of a suitable nonionic surfactant is an ethylenediamine polyoxyethylene surfactant. The amount of surfactant typically is about 0.0001 wt. % to about 1 wt. % (preferably about 0.001 wt. % to about 0.1 wt. %, or about 0.005 wt. % to about 0.05 wt. %) based on the weight of the liquid carrier and any components dissolved or suspended therein.

The electrochemical-mechanical polishing composition optionally further comprises an antifoaming agent. The anti-foaming agent can be any suitable anti-foaming agent. Suitable anti-foaming agents include, but are not limited to, silicon-based and acetylenic diol-based antifoaming agents. The amount of anti-foaming agent present in the polishing composition typically is about 40 ppm to about 140 ppm.

The electrochemical-mechanical polishing composition optionally further comprises a biocide. The biocide can be any suitable biocide, for example an isothiazolinone biocide. The amount of biocide used in the polishing composition typically is about 1 to about 50 ppm, preferably about 10 to about 20 ppm.

As will be understood by those of skill in the art, the electrochemical-mechanical polishing composition of the invention can be produced by any suitable method. Typically, the electrochemical-mechanical polishing composition is produced by adding, in any suitable order, the chemically inert, water-soluble salt, corrosion inhibitor, polyelectrolyte, complexing agent, alcohol, and any other optional additives to the water. In order to ensure that the resulting electrochemical-mechanical polishing composition is homogeneous, the water preferably is stirred as the components are added to the water and/or for a suitable time after the components of the polishing composition have been added to the water. When used in conjunction with a method of polishing a substrate, the electrochemical-mechanical polishing composition of the invention can be used at any suitable time after its preparation. Preferably, the electrochemical-mechanical polishing composition of the invention is used within about 30 days, more preferably within about 10 days (e.g., within about 240 hours), of the preparation of the electrochemical-mechanical polishing composition.

Alternatively, the electrochemical-mechanical polishing composition of the invention can be produced by mixing the components of the polishing composition at or near the point-of-use. As utilized herein, the term “point-of-use” refers to the point at which the electrochemical-mechanical polishing composition is applied to the substrate surface (e.g., the polishing pad or the substrate surface itself). When the electrochemical-mechanical polishing composition is to be produced using point-of-use mixing, the components of the electrochemical-mechanical polishing composition are separately stored in two or more storage devices. A “component” of the electrochemical-mechanical polishing composition, as that term is used herein, can be any single compound or ingredient of the polishing composition (e.g., the chemically inert, water-soluble salt, corrosion inhibitor, polyelectrolyte, complexing agent, alcohol, other optional additive, or water), or any combination of more than one such compound or ingredient (e.g., the corrosion inhibitor, alcohol, and, optionally, at least a portion of the water).

In order to mix the components contained in the storage devices to produce the electrochemical-mechanical polishing composition at or near the point-of-use, the storage devices typically are provided with one or more flow lines leading from each storage device to the point-of-use of the polishing slurry (e.g., the platen, the polishing pad, or the substrate surface). By the term “flow line” is meant a path of flow from an individual storage container to the point-of-use of the component stored therein. The one or more flow lines can each lead directly to the point-of-use, or, in the case that more than one flow line is used, two or more of the flow lines can be combined at any point into a single flow line that leads to the point-of-use. Furthermore, any of the one or more flow lines (e.g., the individual flow lines or a combined flow line) can first lead to one or more of the other devices (e.g., pumping device, measuring device, mixing device, etc.) prior to reaching the point-of-use of the component(s).

The components of the electrochemical-mechanical polishing composition can be delivered to the point-of-use independently (e.g., the components are delivered to the substrate surface whereupon the components are mixed during the polishing process), or the components can be combined immediately before delivery to the point-of-use. Components are combined “immediately before delivery to the point-of-use” if they are combined less than 10 seconds prior to reaching the point-of-use, preferably less than 5 seconds prior to reaching the point-of-use, more preferably less than 1 second prior to reaching the point of use, or even simultaneous to the delivery of the components at the point-of-use (e.g., the components are combined at a dispenser). Components also are combined “immediately before delivery to the point-of-use” if they are combined within 5 m of the point-of-use, such as within 1 m of the point-of-use or even within 10 cm of the point-of-use (e.g., within 1 cm of the point of use).

When two or more of the components are combined prior to reaching the point-of-use, the components can be combined in the flow line and delivered to the point-of-use without the use of a mixing device. Alternatively, one or more of the flow lines can lead into a mixing device to facilitate the combination of two or more of the components. Any suitable mixing device can be used. For example, the mixing device can be a nozzle or jet (e.g., a high pressure nozzle or jet) through which two or more of the components flow. Alternatively, the mixing device can be a container-type mixing device comprising one or more inlets by which two or more components of the polishing slurry are introduced to the mixer, and at least one outlet through which the mixed components exit the mixer to be delivered to the point-of-use, either directly or via other elements of the apparatus (e.g., via one or more flow lines). Furthermore, the mixing device can comprise more than one chamber, each chamber having at least one inlet and at least one outlet, wherein two or more components are combined in each chamber. If a container-type mixing device is used, the mixing device preferably comprises a mixing mechanism to further facilitate the combination of the components. Mixing mechanisms are generally known in the art and include stirrers, blenders, agitators, paddled baffles, gas sparger systems, vibrators, etc.

The electrochemical-mechanical polishing composition of the invention can also be provided as a concentrate which is intended to be diluted with an appropriate amount of water prior to use. In such an embodiment, the electrochemical-chemical mechanical polishing composition concentrate can comprise the chemically inert, water-soluble salt, corrosion inhibitor, polyelectrolyte, complexing agent, alcohol, and other optional additives in amounts such that, upon dilution of the concentrate with an appropriate amount of water, each component of the electrochemical-mechanical polishing composition will be present in the polishing composition in an amount within the appropriate range recited above for each component. For example, the chemically inert, water-soluble salt, corrosion inhibitor, polyelectrolyte, complexing agent, and alcohol can each be present in the concentration in an amount that is about 2 times (e.g., about 3 times, about 4 times, or about 5 times) greater than the concentration recited above for each component so that, when the concentrate is diluted with an equal volume of water (e.g., 2 equal volumes of water, 3 equal volumes of water, or 4 equal volumes of water, respectively), each component will be present in the electrochemical-mechanical polishing composition in an amount within the ranges set forth above for each component. Furthermore, as will be understood by those of ordinary skill in the art, the concentrate can contain an appropriate fraction of the water present in the final electrochemical-mechanical polishing composition in order to ensure that the chemically inert, water-soluble salt, polyelectrolyte, complexing agent, and other suitable additives are at least partially or fully dissolved in the concentrate.

The invention further provides a method of polishing a substrate using the above-described electrochemical-mechanical polishing composition. The method of polishing a substrate according to the invention generally comprises the steps of: (a) providing a substrate, (b) immersing a portion of the substrate in the electrochemical-mechanical polishing composition of the invention, (c) applying an anodic potential to the substrate, and (d) abrading at least a portion of the immersed portion of the substrate to polish the substrate.

More specifically, the invention provides a method of polishing a substrate comprising one or more conductive metal layers, the method comprising the steps of: (a) providing a substrate comprising one or more conductive metal layers, (b) immersing a portion of the substrate in an electrochemical-mechanical polishing composition, the polishing composition comprising: (i) a chemically inert, water-soluble salt, (ii) a corrosion inhibitor, (iii) a polyelectrolyte, (iv) a complexing agent, (v) an alcohol, and (vi) water, (c) applying an anodic potential to the substrate, the anodic potential being applied to at least the portion of the substrate immersed in the polishing composition, and (d) abrading at least a portion of the immersed portion of the substrate to polish the substrate.

The method of the invention can be used to polish any suitable substrate. For example, the electrochemical-mechanical polishing composition and method of the invention are intended for use in the electrochemical-mechanical polishing of substrates, such as microelectronic substrates (e.g., an integrated circuit, memory or rigid disk, metal, ILD layer, semiconductor, thin films, microelectromechanical system, ferroelectric, magnetic head, polymeric film, and low or high dielectric film). The substrate can comprise any suitable insulating, metal, or metal alloy layer (e.g., metal conductive layer). The insulating layer can be a metal oxide, porous metal oxide, glass, organic polymer, fluorinated organic polymer, or any other suitable high or low-K insulating layer. The metal layer can comprise any suitable metal including metals selected from the group consisting of copper, tungsten, aluminum (e.g., at a pH of about 11 or more), titanium, platinum, rhodium, iridium, silver, gold, nickel, ruthenium, and mixtures thereof. Generally, substrates that can be suitably polished using the electrochemical-mechanical polishing composition and method of the invention comprise one or more conductive metal layers. Preferably, the conductive metal layer comprises copper.

The anodic potential can be applied to the substrate by any suitable means. Typically, the apparatus which is used to carry out the method comprises at least two electrodes, one of which is submerged in the electrochemical-mechanical polishing composition and the other of which is coupled to the substrate, for example, through a conductive polishing pad and/or the platen of the polishing apparatus. In such an arrangement, the electrodes typically are connected to a power source and an electric potential or bias is applied to the electrodes so that an anodic (positive) potential is applied to the substrate. The power supply can be adapted to apply a constant current or constant potential to the electrodes and the substrate. In certain embodiments, a constant current can be applied to the electrodes and/or substrate for a first period of time, and then a constant potential can be applied to the electrodes and/or substrate for a second period of time. In such embodiments, the steps of applying a constant current and constant potential to the substrate can be performed in any suitable order. The electric potential applied to the electrodes and/or substrate can be constant or can be varied over time (i.e., a time-varying potential).

The immersed portion of the substrate can be abraded to polish the substrate by any suitable means. Generally, the substrate is abraded using a polishing pad, which pad typically is connected to a polishing platen of the electrochemical-mechanical polishing apparatus. The polishing pad, when present, can be any suitable abrasive or non-abrasive polishing pad.

In certain embodiments, the method of the invention can comprise further steps to be performed before or after at least a portion of the substrate is polished through the application of the anodic potential to the immersed substrate. In particular, the method of the invention can further comprise the step of polishing the substrate using a chemical-mechanical polishing composition. Typically, the aforementioned additional step is performed after the substrate has been polished through the application of an anodic potential to at least the portion of the substrate immersed in the polishing composition of the invention (i.e., step (d) above), and also can be performed without applying an anodic potential to the substrate. The chemical-mechanical polishing composition utilized in this additional step desirably comprises an oxidizing agent. The oxidizing agent can be any suitable oxidizing agent. Preferably, the oxidizing agent is a peroxide (e.g., hydrogen peroxide). In certain embodiments, the electrochemical-mechanical polishing composition of the invention can further comprise an oxidizing agent, thereby allowing the electrochemical-mechanical polishing composition to also be used as the chemical-mechanical polishing composition in the aforementioned additional step.

The method of polishing a substrate according to the invention can be carried out on any suitable apparatus. Suitable electrochemical-mechanical polishing apparatuses include, but are not limited to, the apparatuses disclosed in U.S. Pat. No. 6,379,223, U.S. Patent Application Publication Nos. 2002/0111121 A1, 2002/0119286 A1, 2002/0130049 A1, 2003/0010648 A1, 2003/0116445 A1, and 2003/0116446 A1, as well as International Patent Application WO 03/001581 A2.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electrochemical-mechanical polishing composition comprising:
(a) a chemically inert, water-soluble salt,
(b) a corrosion inhibitor,
(c) a polyelectrolyte,
(d) a complexing agent,
(e) an alcohol, the alcohol being present in the polishing composition in an amount of about 5 wt. % or more based on the total weight of the polishing composition, and
(f) water.

2. The polishing composition of claim 1, wherein the chemically inert, water-soluble salt is potassium sulfate, the corrosion inhibitor is benzotriazole, the polyelectrolyte is poly(acrylic acid), the complexing agent is lactic acid, and the alcohol is propanol.

3. The polishing composition of claim 2, wherein the chemically inert, water-soluble salt is present in the polishing composition in an amount of about 0.5 to about 4 wt. % based on the total weight of the polishing composition, and the alcohol is present in the polishing composition in an amount of about 15 to about 20 wt. % based on the total weight of the polishing composition.

4. The polishing composition of claim 1, wherein the chemically inert, water-soluble salt is present in the polishing composition in an amount of about 0.5 to about 10 wt. % based on the total weight of the polishing composition.

5. The polishing composition of claim 1. wherein the polishing has a pH of about 7 or less.

6. The polishing composition of claim 1, wherein the polishing composition comprises:
(a) a chemically inert, water-soluble salt selected from the group consisting of chlorides, phosphates, sulfates, and mixtures thereof,
(b) a corrosion inhibitor selected from the group consisting of 1,2,3-triazole, 1,2,4-triazole, benzotriazole, benzimidazole, benzothiazole, and mixtures thereof,
(c) a polyelectrolyte selected from the group consisting of arabic gum, guar gum, hydroxypropyl cellulose, poly(acrylic acid), poly(acrylic acid-co-acrylamide), poly(acrylic acid-co-2,5-furandione), poly(acrylic acid-co-acrylamidomethylpropylsulfonic acid), poly(acrylic acid-co-methyl methacrylate-co-4-[(2-methyl-2-propenyl)oxy]-benzenesulfonic acid-co-2-methyl-2-propene-1-sulfonic acid), poly(acrylamide), poly(N-sulfopropyl acrylamide), poly (2-acrylamido-2-methylpropane sulfonic acid), poly(diallyl dimethyl ammonium chloride), poly(ethylene glycol), poly(ethylene imine), poly(methacrylic acid), poly(ethyl methacrylate), poly(sodium methacrylate), poly(sulfopropyl methacrylate), poly(maleic acid), poly(maleic-co-olefin), poly(vinyl alcohol), poly(anilinesulfonic acid), poly(ethenesulfonic acid), poly(styrenesulfonate), poly(styrene-co-maleic acid), poly(sodium 4-styrenesulfonate), poly(vinylsulfonate), poly(vinyl pyridine), poly(sodium vinyl sulfate), poly(ethenesulfonic acid), succinylated poly-L-lysine, poly[aniline-co-N-(3-sulfopropyl) aniline], sodium alginate, xanthan gum, and mixtures thereof,
(d) a complexing agent selected from the group consisting of carboxylic acids, di-carboxylic acids, tri-carboxylic acids, polycarboxylic acids, and mixtures thereof,
(e) an alcohol selected from the group consisting of methanol, ethanol, propanol, butanol, and mixtures thereof, the alcohol being present in the polishing composition in an amount of about 5 wt. % or more based on the total weight of the polishing composition, and
(f) water.

7. The polishing composition of claim 6, wherein the chemically inert, water-soluble salt is present in the polishing composition in an amount of about 0.5 to about 10 wt. % based on the total weight of the polishing composition.

8. The polishing composition of claim 6, wherein the corrosion inhibitor is benzotriazole.

9. The polishing composition of claim 6, wherein the polyelectrolyte is poly(acrylic acid).

10. The polishing composition of claim 6, wherein the complexing agent is selected from the group consisting of lactic acid, tartaric acid, citric acid, malonic acid, phthalic acid, succinic acid, glycolic acid, propionic acid, acetic acid, salicylic acid, picolinic acid, 2-hydroxybutyric acid, 3-hydroxybutyric acid, 2-methyl lactic acid, salts thereof, and mixtures thereof.

11. The polishing composition of claim 10, wherein the complexing agent is lactic acid.

12. The polishing composition of claim 6, wherein the alcohol is propanol.

13. The polishing composition of claim 6, wherein the alcohol is present in an amount of about 15 to about 25 wt. % based on the total weight of the polishing composition.

14. The polishing composition of claim 6, wherein the polishing composition has a pH of about 7 or less.

15. A method of polishing a substrate comprising one or more conductive metal layers, the method comprising the steps of:
(a) providing a substrate comprising one or more conductive metal layers,
(b) immersing a portion of the substrate in an electrochemical-mechanical polishing composition, the polishing composition comprising:
(i) a chemically inert, water-soluble salt,
(ii) a corrosion inhibitor,
(iii) a polyelectrolyte,
(iv) a complexing agent,
(v) an alcohol, the alcohol being present in the polishing composition in an amount of about 5 wt. % or more based on the total weight of the polishing composition, and
(vi) water,
(c) applying an anodic potential to the substrate, the anodic potential being applied to at least the portion of the substrate immersed in the polishing composition, and
(d) abrading at least a portion of the immersed portion of the substrate to polish the substrate.

16. The method of claim 15, wherein the conductive metal layer comprises copper.

17. The method of claim 16, wherein the chemically inert, water-soluble salt is potassium sulfate, the corrosion inhibitor is benzotriazole, the polyelectrolyte is poly(acrylic acid), the complexing agent is lactic acid, and the alcohol is propanol.

18. The method of claim 15, wherein the chemically inert, water-soluble salt is present in the polishing composition in an amount of about 0.5 to about 4 wt. % based on the total weight of the polishing composition, and the alcohol is present in the polishing composition in an amount of about 15 to about 20 wt. % based on the total weight of the polishing composition.

19. The method of claim 15, wherein the chemically inert, water-soluble salt is present in the polishing composition in an amount of about 0.5 to about 10 wt. % based on the total weight of the polishing composition.

20. The method of claim 15, wherein the polishing composition has a pH of about 7 or less.

21. The method of claim 15, wherein the polishing composition comprises:
(i) a chemically inert, water-soluble salt selected from the group consisting of chlorides, phosphates, sulfates, and mixtures thereof,
(ii) a corrosion inhibitor selected from the group consisting of 1,2,3-triazole, 1,2,4-triazole, benzotriazole, benzimidazole, benzothiazole, and mixtures thereof,
(iii) a polyelectrolyte selected from the group consisting of arabic gum, guar gum, hydroxypropyl cellulose, poly(acrylic acid), poly(acrylic acid-co-acrylamide), poly(acrylic acid-co-2,5-furandione), poly(acrylic acid-co-acrylamidomethylpropylsulfonic acid), poly(acrylic acid-co-methyl methacrylate-co-4-[(2-methyl-2-propenyl)oxy]-benzenesulfonic acid-co-2-methyl-2-propene-1-sulfonic acid), poly(acrylamide), poly(N-sulfopropyl acrylamide), poly (2-acrylamido-2-methylpropane sulfonic acid), poly(diallyl dimethyl ammonium chloride), poly(ethylene glycol), poly(ethylene imine), poly(methacrylic acid), poly(ethyl methacrylate), poly(sodium methacrylate), poly(sulfopropyl methacrylate), poly(maleic acid), poly(maleic-co-olefin), poly(vinyl alcohol), poly(anilinesulfonic acid), poly(ethenesulfonic acid), poly(styrenesulfonate), poly(styrene-co-maleic acid), poly(sodium 4-styrenesulfonate), poly(vinylsulfonate), poly(vinyl pyridine), poly(sodium vinyl sulfate), poly(ethenesulfonic acid), succinylated poly-L-lysine, poly[aniline-co-N-(3-sulfopropyl) aniline], sodium alginate, xanthan gum, and mixtures thereof,
(iv) a complexing agent selected from the group consisting of carboxylic acids, di-carboxylic acids, tri-carboxylic acids, polycarboxylic acids, and mixtures thereof,
(v) an alcohol selected from the group consisting of methanol, ethanol, propanol, butanol, and mixtures thereof, the alcohol being present in the polishing composition in an amount of about 5 wt. % or more based on the total weight of the polishing composition, and
(vi) water.

22. The method of claim 21, wherein the conductive metal layer comprises copper.

23. The method of claim 21, wherein the chemically inert, water-soluble salt is present in the polishing composition in an amount of about 0.5 to about 10 wt. % based on the total weight of the polishing composition.

24. The method of claim 21, wherein the corrosion inhibitor is benzotriazole.

25. The method of claim 18, wherein the polyelectrolyte is poly(acrylic acid).

26. The method of claim 21, wherein the complexing agent is selected from the group consisting of lactic acid, tartaric acid, citric acid, malonic acid, phthalic acid, succinic acid, glycolic acid, propionic acid, acetic acid, salicylic acid, picolinic acid, 2-hydroxybutyric acid, 3-hydroxybutyric acid, 2-methyl lactic acid, salts thereof, and mixtures thereof.

27. The method of claim 26, wherein the complexing agent is lactic acid.

28. The method of claim 21, wherein the alcohol is propanol.

29. The method of claim 21, wherein the alcohol is present in the polishing composition in an amount of about 15 to about 25 wt. % based on the total weight of the polishing composition.

30. The method of claim 21, wherein the polishing composition has a pH of about 7 or less.
